(19) United States
(12) Patent Application Publication
(10) Pub. No.: US 2015/0000701 A1
(43) Pub. Date: Jan. 1, 2015

(54) METHOD AND APPARATUS FOR CLEANING DIESEL PARTICULATE FILTERS

(71) Applicants: Mark TEVELEY, (US); Byron KIESER, (US)

(72) Inventors: Mark Tevely, Fort McMurray (CA); Byron Kieser, Beeton (CA)

(21) Appl. No.: 14/353,124

(22) PCT Filed: Oct. 22, 2012
(86) PCT No.: PCT/CA2012/050752

§ 371 Date: Apr. 21, 2014

Related U.S. Application Data
(60) Provisional application No. 61/549,596, filed on Oct. 20, 2011.

(51) Int. Cl. F01N 3/023; B01D 53/96; B08B 3/08

(52) U.S. Cl. CPC F01N 3/0232; B08B 3/08; B01D 53/96
USPC 134/10; 134/34; 134/27

(57) ABSTRACT

An apparatus and method for removing accumulated ash and soot from DPFs which uses a combination of ultrasonic energy coupled via a liquid cleaning solution to the internal and external surfaces of the DPF to dislodge and remove the accumulated materials, and a system of directing clean solution for rinsing of the filter elements by continuous filtration of the rinse solution, and a means of drawing residual material-laden cleaning solution from the filter to complete the cleaning process.

### FIELD

This relates to a method and apparatus for cleaning diesel particulate filters (DPF) using pressure waves in a cleaning solution.

### BACKGROUND

Diesel Particulate Filters (DPFs) are widely employed as a means to reduce the particulate matter in diesel exhaust in many applications where diesel engines are used, such as heavy industrial equipment, locomotive equipment, commercial transport vehicles, passenger vehicles, generators, farm equipment, mining equipment, and the like. These filters generally are comprised of a honeycomb-like ceramic filter, often with a catalytic coating, which effectively filters the soot particles from the exhaust gases of the engine, and promotes the conversion of these soot particles to ash during regenerative combustion processes, Such a filter is described in U.S. Pat. No. 7,047,731 (Foster et al) entitled “Diesel particulate filter ash removal”.

The filters eventually become clogged or partly clogged with ash and soot, reducing the effectiveness of the filter and the engine efficiency, eventually preventing the engine from operating at all. Part of the maintenance of these filters involves the removal of the accumulated ash and soot, by a number of means, to restore the operational characteristics of the filter.

DPFs occur in many forms, and may be filter elements mounted permanently in a housing with the necessary inlet and outlet flanges for connection to the exhaust system, or may be removable elements in a housing which may be disassembled to facilitate inspection, cleaning or replacement.

U.S. Pat. No. 7,357,829 (Ehlers) entitled “Diesel particulate filter cleaning device and method” describes a system for cleaning DPFs by applying pulses of a compressible fluid, such as air, in a reverse direction to dislodge and eject material collected in the filter, There are several commercially available systems which utilize a similar principle to effect cleaning of the DPF and return to operation.

It is generally believed that the use of ultrasonics in the cleaning of DPF filters presents a risk to the catalytic coating present on many filter designs (commonly referred to as the “washcoat”). For example, U.S. Pat. No. 6,929,701 (Patel) entitled “Process for decoating a washcoat catalyst substrate” describes a process in which an ultrasonic bath is used with a series of aqueous solutions to effectively remove the washcoat from the DPF substrate. In addition, U.S. Pat. No. 7,025,811 (Streichsbier et al) entitled “Apparatus for cleaning a diesel particulate filter with multiple filtration stages” refers to possible damage to the catalytic coating or support materials caused by ultrasonic. and fluid treatments. Furthermore, a paper entitled “Diesel Particulate Traps Regenerated by Catalytic Combustion” (I). Fino, P. Fiino, C. Saracco and V. Specchia, Korean Chem. Fog., 20(3), 445450, 2003) refers to the use of an ultrasonic bath as a means to dislodge catalyst material, or the washcoat.

United States patent application publication no. 20050011357 (Crawley) entitled “Method and system for flushing ash from a diesel particulate filter” refers to a system of flowing fluids through the DPF where sonic energy may be injected into the fluid to assist in the dislodging of material as the fluid flows through the DPF.

### SUMMARY

According to an aspect, there is provided a method of cleaning a diesel particulate filter (DPI') that comprises filter elements in a housing, the filter elements having a catalyst layer and being contaminated with contaminants, the method comprising the steps of: providing a cleaning vessel containing a cleaning liquid, the cleaning liquid being non-reactive with the catalyst layer; submerging at least a portion of a DPF in the cleaning liquid in the vessel; operating one or more acoustic transducers in a frequency range of 20 kHz to 100 kHz to induce pressure waves in the cleaning liquid that separate the filtered materials from the filter elements within the housing without removing the catalyst layer; and removing the DPF from the cleaning liquid.

According to an aspect, the method may further comprise the step of rinsing the DPF after removal from the cleaning liquid. The DPF may be dried after rinsing.

According to an aspect, the method may further comprise repeating one or more steps listed above.

According to an aspect, the cleaning liquid may comprise one or more of a group consisting of water, aqueous solution, surfactant, solvent, acidic solution, basic solution, and mixtures thereof.

According to an aspect, the DPF element may be transferred into and from the cleaning vessel by a hoist.

According to an aspect, the cleaning vessel may comprise one or more acoustic transducers capable of operating at frequencies between 20 kHz and 100 kHz. The one or more acoustic transducers may be mounted to the cleaning vessel, the cleaning vessel being separate and distinct from the DPF. The one or more acoustic transducers may be mounted inside the cleaning vessel. The one or more acoustic transducers may be mounted outside the cleaning vessel. The one or more acoustic transducers may be mounted using one of a fixed mount, a flexible mount, or a freely hanging mount. The one or more acoustic transducers may be oriented in such a way as to deliver acoustic energy through the cleaning liquid to the exterior and interior surfaces of the DPF. The one or more acoustic transducers may generate pressure waves radially or longitudinally.

According to an aspect, rinsing the DPF may comprise circulating fluid through the housing of the DPF.

According to an aspect, the cleaning vessel may comprise a fluid exchange system having one or more pumps and one or more filters for separating solid contaminants from the cleaning fluid removed from the DPF. Settling tanks may be used to separate solid contaminants. The separated cleaning fluid is used to rinse the DPF. The one or more filters may comprise gravitational, centrifugal and size exclusion filters. The cleaning liquid in the cleaning tank may be exchanged such that the solid contaminants removed from the DPF are separated from the cleaning liquid, the separated cleaning liquid being reused for at least one of cleaning and rinsing the DPF.

According to an aspect, the DPF may be dried using a vacuum system. The vacuum system may induce a local low pressure region in the DPF to promote cross channel flows. The vacuum system may be coupled to the DPF when the filter elements are not removable from the DPF. The air drawing through the DPF by the vacuum system may he heated, The method may further comprise the step of monitoring one or more of the airflow, the temperature, the pressure drop and the humidity of an air flow drawn through the DPF by the vacuum system to monitor the drying step. The vacuum system may also or alternatively be used to test the integrity of the DPF.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1A is a side elevation view of a diesel particulate filter (DPF)

FIG. 1B is a side elevation view in section of a DPF.

FIG. 1C is a detailed perspective view am interior or a DPF.

FIG. 2 is a flow chart of a method of cleaning a DPF.

FIG. 3 is a side elevation view of an apparatus for cleaning a DPF.

FIG. 4 is a side elevation view of an apparatus for rinsing a DPI'.

FIG. 5 is a schematic view of a control system for an apparatus for cleaning and rinsing a DPF.

FIG. 6 is a schematic View of a liquid recirculation system of the final rinse tank,.

FIG. 7 is a top plan view of an alternate vacuum liquid removal and drying apparatus.

FIG. 8 is a side elevation view of a drying system for drying a DPF.

### DETAILED DESCRIPTION OF PREFERRED EMBODIMENT

It has been found that through the use of specific aqueous surfactant solutions and the application of ultrasonic energy in the absence of flow, accumulated ash and soot from a diesel particulate filter (DPF) without having a measurable detrimental effect on the catalytic washcoat when combined with a series of flushing and drying steps.

In this document, the reference numerals are specific to the figure that are referred to, and like numerals do no refer to like elements in different figures.

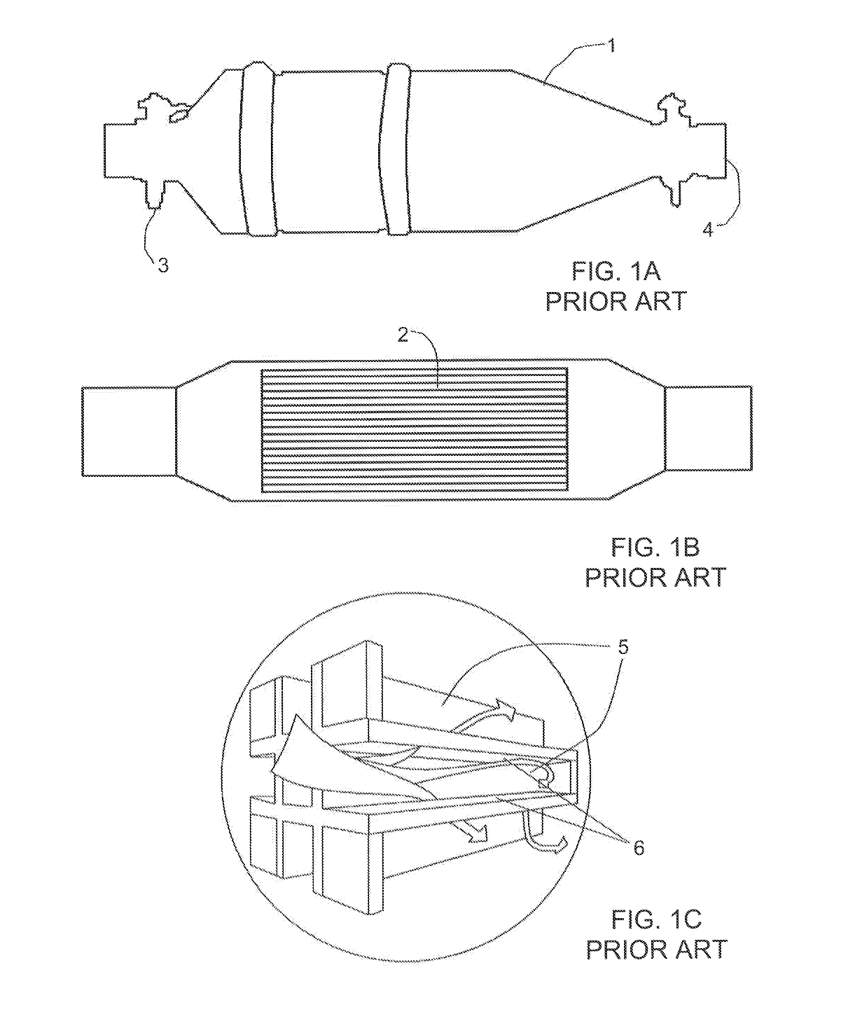

FIG. 1 shows an example of a DPF Filter in whole and cross section, demonstrating the removable or non-removable outer shell (1), the ceramic “honeycomb” filter elements (2), the inlet (3) and outlet (4) flange, and the individual element channels (5) with accumulated soot and ash (6).

The object of cleaning the DPF is to remove a sufficient amount of the accumulated ash and soot to allow the DPF to be reused, leaving cleaned passageways in the honeycomb, and to do so without negatively affecting any catalytic coating (referred to as a washcoat), either by removal of the washcoat or chemical deactivation.

It has been found that a combination of ultrasonic energy, and a suitable cleaning solution can effectively loosen, dislodge and remove the accumulated material with no negative impact on the washcoat. Specific tests to examine the structure of a typical washcoat and the impact of the cleaning process on this washcoat have been conducted and it was determined that there is no significant removal of the washcoat during cleaning (<1%). A suitable cleaning solution is one that is not reactive with the washcoat and may include one or more surfactants, and/or solvents or mixtures of solvents, acidic or basic solutions, or any liquid which has the necessary properties to effectively remove the accumulated materials from the DPF. Suitable concentrations of aqueous degreasing solutions containing surfactants and corrosion inhibitors may be arrived at through testing. The concentration may be optimized to balance the activity of the solution to wet the soot/ash for removal and allow easy rinsing. It has been found that solvent degreasers containing organic solvents in addition to surfactants/corrosion inhibitors may be effective as a pretreatment for units heavily fouled with hydrocarbons such as engine oil or fuel.

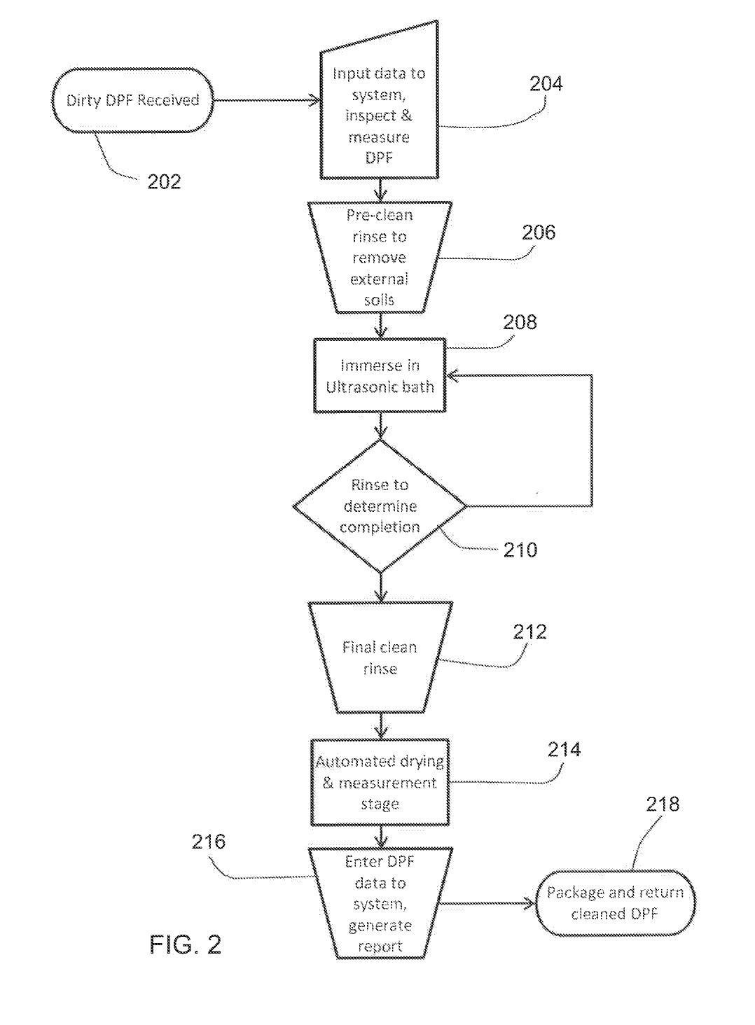

FIG. 2 describes an example of an overall process that may be employed using a flowchart. According to the example, the first step of the depicted process is the receipt of a fouled (dirty) DPF filter from a client (step 202). Next, data such as the serial number of the unit, and an initial inspection and flow test of the DPF is performed (step 204). A pre-clean rinse is then used to remove any loose external soils (step 206) and the unit is immersed in an ultrasonic bath containing a cleaning fluid (step 208). Afterward, the unit is rinsed and visually inspected (step 210). If the unit is not determined to be cleaned, it is returned to the ultrasonic bath for a time. The inspection and re-immersion is repeated until the unit is cleaned. A final rinse with clean water is carried out to remove any residual materials and improved the visual appearance of the DPF unit (step 212). The DPF is then dried using a high flow rate of air, with alternating pressure drops across the DPF and the flow rate, pressure drop, and humidity data are recorded as a measure of the DPF performance and cleanliness (step 214). Once clean, the DPF is packaged and the work order completed (step 216) and the clean DPF is returned to the client (step 218).

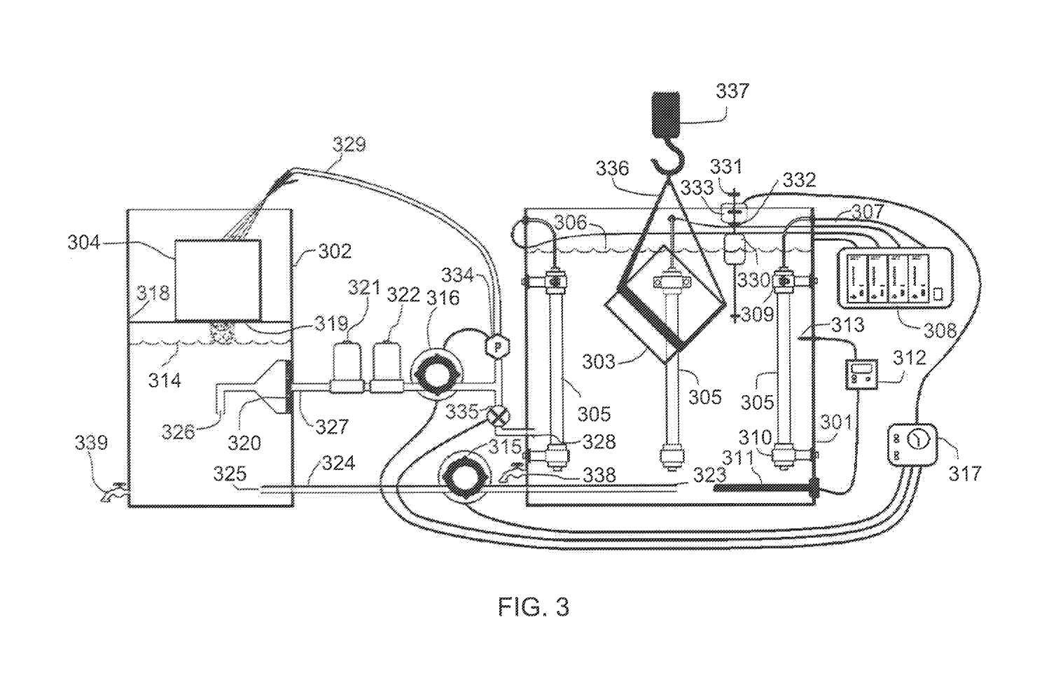

FIG. 3 shows an example of an ultrasonic cleaning (301) and initial rinse (302) vessel. The cleaning vessel (301) and rinse vessel (302) are of a size appropriate to the DPI; filter(s) which will be cleaned. Two DPF filters are depicted as (303) and (304) and are suspended in the cleaning vessel or resting in the initial rinse vessel, depending on the stage of cleaning. The cleaning tank preferably contains a number of ultrasound transducers (305) arranged around the interior of the vessel, submerged in the cleaning liquid (306). The ultrasound transducers may be connected by wires (307) to an electronic signal generator (308) which provides the high power ultrasound transducer drive signals. The ultrasound transducers may be operated at frequencies from 1 kHz to 1 MHz, depending on the size of the tank, and the size of the objects being cleaned. Generally, the higher frequencies produce “softer” but more tightly spaced acoustic activity, and are more suitable for cleaning small structures, while lower frequencies are able to penetrate deeper with higher energy. Preferably, the transducers will be operated in the range of 20 kHz to 100 kHz. The transducers may be mounted by a fixed, flexible mount, or freely hanging. As shown, transducers are mounted using a clamp (309) which secures the top of the transducer and a lower clamp (310) which may be either loose fitting or tight. The transducers may be fixed to the outside, inside, or otherwise immersed in the cleaning vessel. The transducers are oriented in such a way as to deliver acoustic energy through the fluid coupling media, i.e. the cleaning liquid, to the exterior and interior surfaces of the DPF. The transducers may be any proprietary or commercially available product which: converts electrical energy into mechanical vibrations through the expansion and contraction, whether radially or longitudinally, of an electromechanical device, such as a piezoelectric element, or a plurality of mechanically and electrically coupled piezoelectric elements, or any other form of electromechanical device. Transducers are generally coupled to the fluid by means of a mechanical diaphragm of sorts, or through the radial expansion and contraction of a resonant tube or rod into which acoustic energy is delivered through the vibration of the electromechanical elements at either or both ends, or through any type of resonator designed to conduct the vibrations of the electromechanical elements to the liquid in the cleaning vessel.

The cleaning liquid (306) is preferably maintained at a temperature between 50-90° C. using, for example, an immersion heater (311) controlled electronically using an electronic controller (312) which senses the liquid temperature by means of a temperature sensor (313) immersed in the liquid.

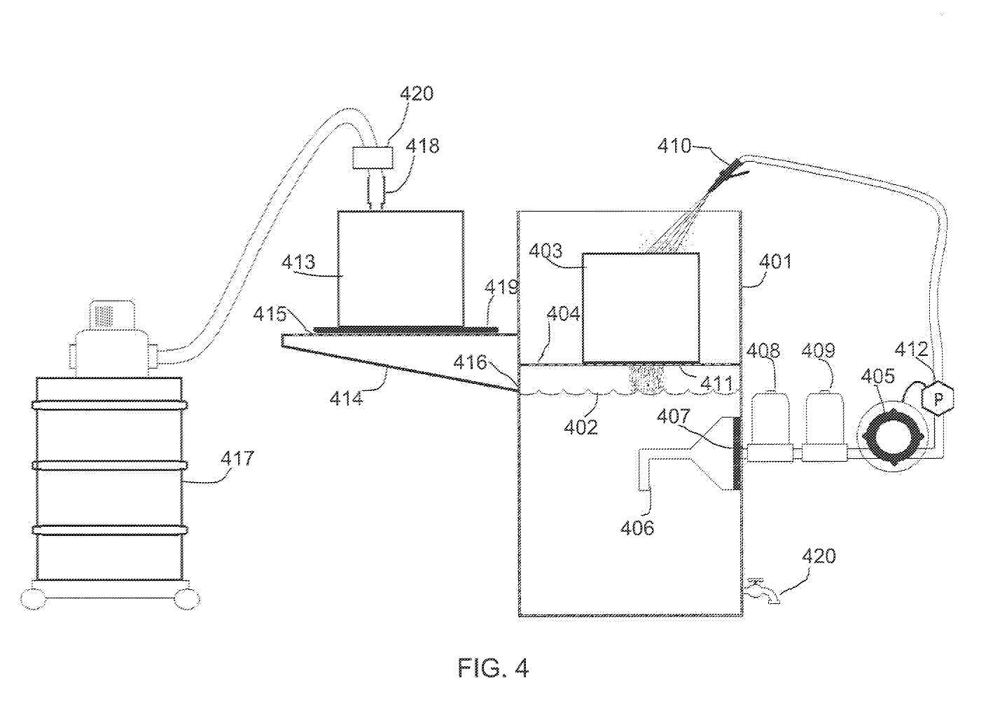

The initial rinse tank (302) may contain the same cleaning liquid (314) as is held in the cleaning vessel (301). The cleaning liquid may then be exchanged between the cleaning vessel (301) and the rinse tank (302) by means of two electrically operated pumps. A first pump (315) transfers solution from the cleaning tank to the rinse tank, and a second pump (316) returns filtered liquid to the cleaning vessel by drawing through a series of filter elements. The depicted pumps are controlled by electronics (317) that are detailed in FIG. 4, and utilize a float (330) with adjustable limits (331) and (332), level switch (333), pressure switch (334) and solenoid valve (335). The transfer and exchange of liquid may be automated such that it occurs periodically or as required. The initial rinse tank as depicted contains an internal shelf (318) which supports the DPF being rinsed (304) and has perforations (319) that allow any rinse liquid to drain into the vessel. Filtered cleaning liquid is delivered back to the cleaning vessel from the initial rinse vessel by drawing liquid through one or more filter elements, such as gravitational (i.e. settling tanks), centrifugal and size exclusion filters, in combination or alone. In the depicted example, there is a series of replaceable filter elements beginning with a coarse fibre/screen (320), followed by a centrifugal filter (321) for removing heavy particles, and a final fine particle (<10 um) filter (322), while the filtered contaminants accumulate in the vessel. The residues that are removed may include fine particulate ash, soot, oil, grease, metal particles and the like that accumulated in the DPF during operation. The overall circulation of cleaning liquid in the depicted example is as follows: pump (315) draws dirty cleaning liquid from the cleaning tank (301) through the opening (323) of tube (324), discharging through the tube exit (325) into the rinse tank (302). Filtered liquid is returned to the cleaning tank (301) from the rinse tank (302) by pump (316) which draws dirty liquid through the opening (326) of tube (327), drawing through multiple filter stages (320, 321, 322) and then delivering through the solenoid valve (335) to the cleaning tank (301) through tube opening (328). Alternatively, or simultaneously, rinse liquid may be circulated by pump (316) through flexible hose & sprayer (329) to the upper surface of the DPF (304).

The DPF may be suspended in the cleaning tank using any number of common approaches, such as a sling (336) with block and tackle (337) as depicted, which is used to lower, suspend, raise, and transfer the DPF to the rinse tank. The mechanism of (336) and (337) may also include any design of clamp, basket, shelf, etc. and may be robotically operated under manual or automated control. Drain valves (338) and (339) provide a means to drain the vessels for cleaning and liquid replacement.

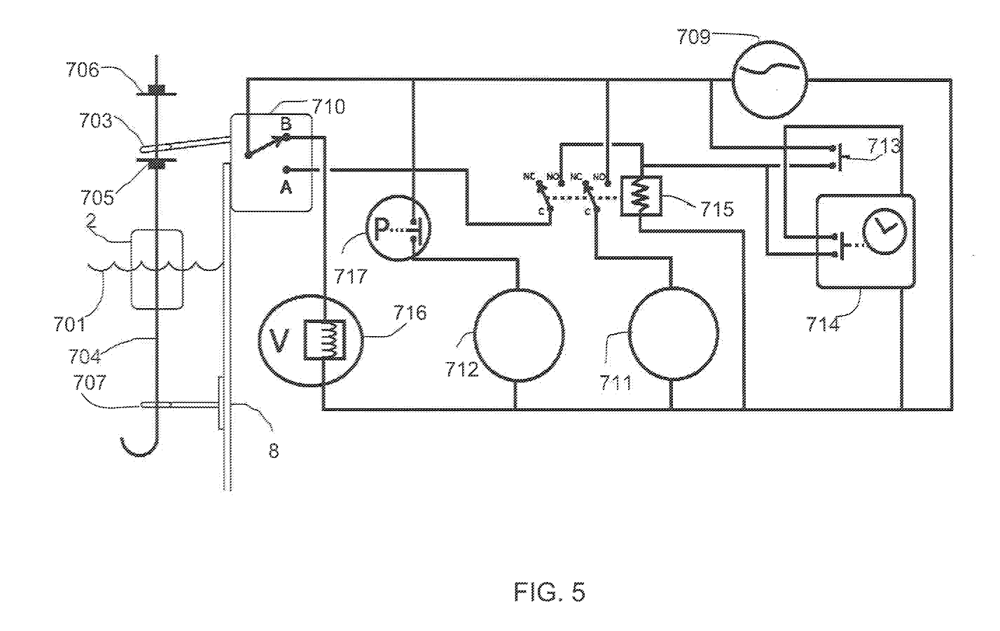

FIG. 4 shows the details of an example of a final rinse vessel (401). This vessel is constructed of appropriate size for the DPF(s) being cleaned. The final rinse liquid (402) is held in the vessel and will be used to rinse the DPF (403) of any residual materials. The depicted vessel (401) contains an internal shelf (404) with perforations (411). The rinse liquid is circulated by pump (405), drawing liquid through the opening (406) of a coarse filter (407), then through subsequent particle filters (408) and (409) and delivering to the DPF (403) surface for rinsing through flexible tube/nozzle (410). Fluid falling through the DPF (403) drains back into the vessel through perforations (411) in the shelf (404). The operation of the pump is controlled automatically using a pressure switch (412) as detailed in FIG. 5.

As shown, a vacuum system is used to draw any remaining liquid from the DPF (413) resting on a shelf (414) extending from the side of the final rinse vessel (401). The vacuum system draws air, liquid and any debris from the DPF (413) and also preferably induces a local low pressure region in the DPR (413) to promote cross channel flows during the vacuum cleaning process. This shelf has a perforated upper surface (415), with a sloped bottom that allows any liquid draining from the DPF during transfer or drying to drain back into the vessel through opening (416). A commercially available vacuum system (417) capable of drawing a mixture of air, liquids and solids is used to draw any remaining liquid or contaminants from the DPF (413) through tube (418) which has a soft rubber opening. A soft (rubber, foam, etc.) mat (419) is preferably used to provide a moderate seal at the bottom of the DPF (413) channels to aid in the drawing of material and liquid and speed drying of the DPF (413) channels. A drain valve (402) provides a means to drain the vessel for cleaning and liquid replacement. The vacuum drying process may be automated with a combination of computer controlled valves and sensors to measure airflow, pressure drop across the DPF, temperature, and humidity of the air drawn through the filter. Such a system may also be used to measure the DPF performance before cleaning, thus providing a means to assess the cleanliness/dryness of the DPF and the effect of the cleaning procedure.

The induction of a low pressure region and airflow through the DPF during drying helps dislodge and remove any remaining material. In addition, the low pressure region helps to dry the unit faster as the air flow supplies heat for vaporization and the reduced pressure increases the rate. In some circumstances, it may be beneficial to heat to the airflow used to dry the DPF, as well the monitoring the pressure drop, airflow, temperature and humidity of the air flowing through the DPF. In one example, the vacuum source may be a high volume blower capable of drawing 200-400 cfm for example, or an airflow which is typical of the types of airflow the DPF would see in use. Not only does this help dry the unit faster, it also provides a more realistic test of the unit. In FIG. 4, the vacuum system (417) is shown as coupled to the DPF (413) just by pressing the vacuum hose (418) to the face of the unit. In one example, the vacuum unit (417) may be the high volume blower mentioned above, and coupled to the entire outlet face of the DPF (413), and on the other face of the unit an inlet housing is coupled to the inlet end of the DPF. In the outlet end, pressure, humidity, temperature and airflow sensors, represented by a sensor unit (420), are employed to monitor the completion of drying and test the airflow of the unit.

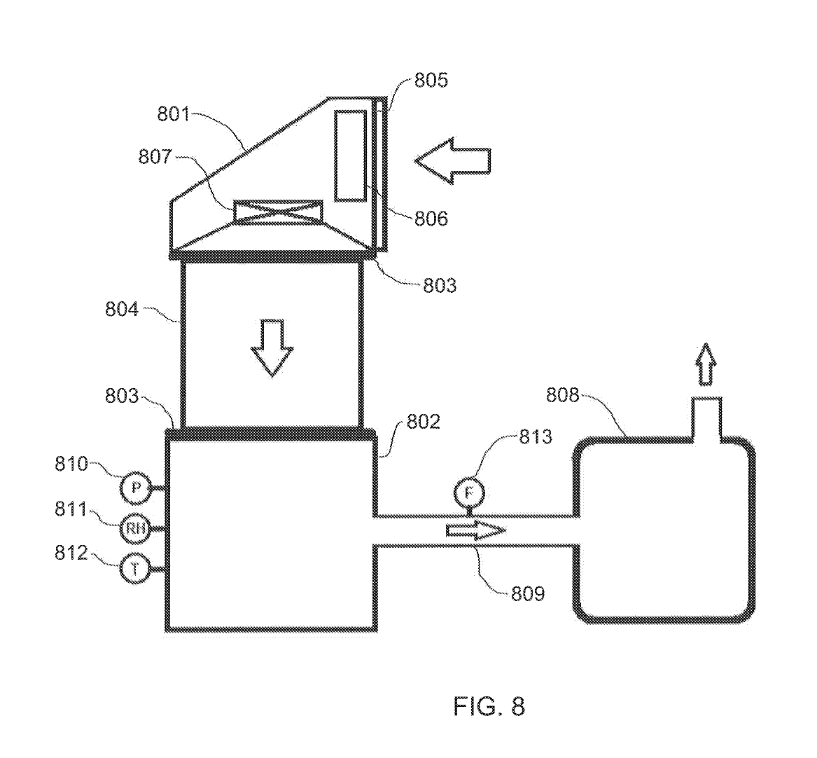

An example of a drying system is shown in more detail in FIG. 8. The drying system includes an upper housing (801), a lower housing (802), and gaskets (803) that seal either side of DPF (804) to be dried. The upper housing (801) has an air filter (805) and a heater (806) at its inlet to provide clean, heated air to the DPF (804). The upper housing (801) also has a valve (807) at its outlet that allows the air flow through the DPF (804). By controlling the position of valve (807), the pressure can be reduced as required to dry and test the DPF (804). The lower housing (802) is connected to a vacuum source, such as a blower (808) by a hose (809). The lower housing (802) has a pressure sensor (810), a humidity sensor (811) and a temperature sensor (812), while an airflow sensor (813) is positioned on the hose (809). More or fewer sensors may be used, as desired by the user. For example, sensors may be desired at the inlet of the DPF (804) in order to compare the air flow.

An example of a control system will now be discussed with reference to FIG. 5, which relates to a control system for the pumps that circulate liquid between the cleaning and initial rinse vessels. There are two basic operations, drain and fill, and the system is designed to automatically exchange dirty liquid from the cleaning vessel with filtered liquid from the initial rinse vessel, and to supply filtered liquid from the rinse vessel for rinsing the DPF at elevated pressure. A liquid (501) level sensor is implemented by means of a float (502) and float switch arm (503) operated by the vertical motion of the float rid (504) and adjustable upper level (505) and lower level (506) cams which contact and move the switch arm (503) under the buoyant force or weight of the float. The float is constrained to vertical motion via the rod (504), float switch arm (503) and lower guide (507) which is fixed to the wall of the vessel (508).

The entire system is typically powered from AC mains but may be alternately powered by any electrical source with the appropriate components. The system may be controlled manually or by an automated system, as will be described. The system operation of the depicted example is explained thus: Assume that the switch (510) is in position “A”, i.e. the float is at the top of its travel and thus the liquid (501) level is at the higher limit. The timer of (514) is designed to deliver a periodic signal which operates relay (515). This signal may be also generated manually by the operator by activating momentary switch (513). When relay (515) is activated it latches, with the energizing signal provided through switch (510) and activates the drain pump (511). Drain pump (511) will continue to operate, transferring liquid from the cleaning vessel to the initial rinse vessel, until such time as the liquid (501) level has been reduced to the point that the float (502) and lower limit cam (506) activate switch (510) via switch arm (503), changing it to position “B”. At this point, relay (515) is de-energized and the drain pump (511) shuts off At this point also, solenoid valve (516) is energized through switch (510), which relieves any pressure in the fill system, thus activating pressure switch (517) which in turn energizes the fill pump (512). The fill pump (512) will transfer liquid from the initial rinse vessel to the cleaning vessel until such time as the float (502) is raised to a point where the upper level cam (505) operates the switch (510) through switch arm (503), at which point the solenoid valve (516) is de-energized, thus allowing pressure in the fill system to build to the point where the pressure switch (517) is deactivated, shutting off the fill pump. At any time, the operator may use the flexible hose and nozzle which is part of the fill system to rinse a DPF in the initial rinse tank, and in this case, pressure on the line is relieved, thus causing the pressure switch (517) to activate, energizing the fill pump (512), and delivering filtered liquid for rinsing as long as it is required.

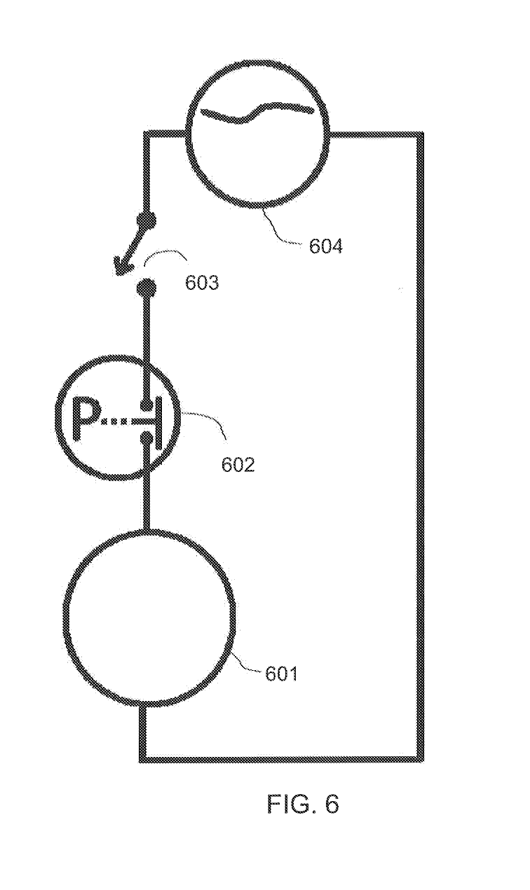

FIG. 6 shows an electrical schematic of the liquid recirculation system of the final rinse tank. The pump (601) that draws liquid from the tank through a series of filters as shown in FIG. 4, and then supplies the liquid under pressure to the rinse nozzle, is energized by a pressure switch which activates when the pressure drops below 90 psi. When an operator opens the spray nozzle, the pressure in the system drops instantly and activates the pump. When the nozzle is closed, the pressure increases above the upper pressure switch limit (approximately 100 psi) and shuts off. The AC power (604) for the system.

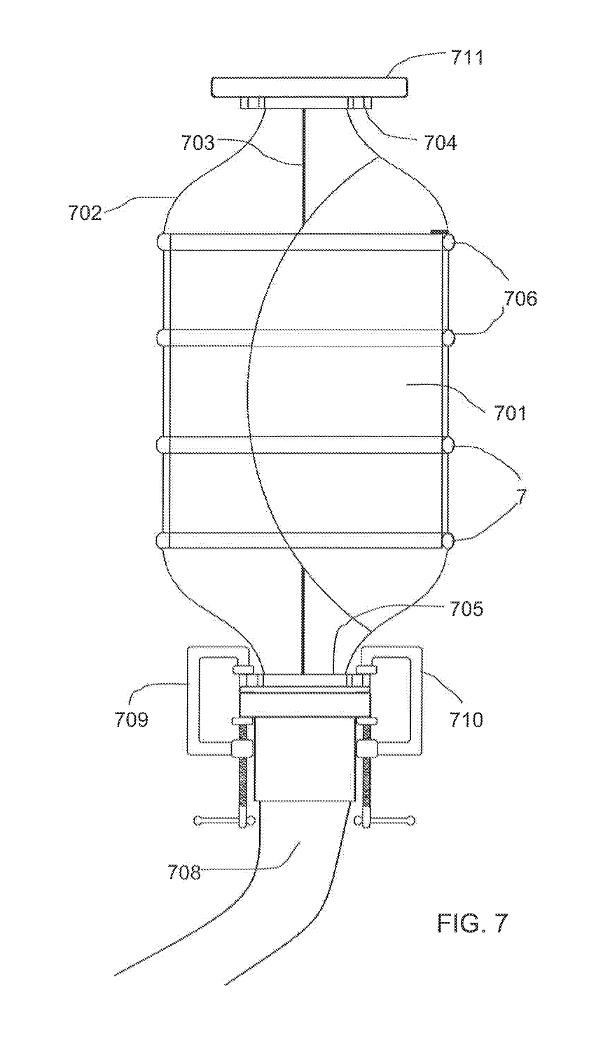

FIG. 7 details an alternate vacuum liquid removal and drying embodiment, which is used in situations where it is not possible to disassemble the DPF for cleaning. A representative DPF assembly is shown in which the DPF element (701) is encased in a sealed (typically metal) container (702) comprised of two or more shell pieces welded (703) together, with flanges (704) and (705) at the inlet and outlet end to connect to the engine exhaust system, The DPF element is held in place within the canister by gasket materials (706) and (707). With this sort of DPF, the entire unit is immersed in the cleaning vessel, and rinsed in the subsequent initial and final rinse vessels. A special flange (708) is constructed for the vacuum system described previously, and is sealed to the inlet side of the DPF assembly using simple clamps (709) and (710). A piece of flat rubber material (711) is used at the outlet side of the DPF unit to form an easily removed seal, and in operation of the vacuum system, this seal is placed and removed repeatedly to allow the creation of negative pressure and promote cross channel airflow to aid in the removal of any residual liquid and drying of the filter. In addition, a small amount of rinse water, using the rinse water vessel shown in FIG. 3, may be used to help remove any remaining discolouration.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples above.

What is claimed is:

1. A method of cleaning a diesel particulate filter (DPF) that comprises filter elements in a housing, the filter elements having a catalyst layer and being contaminated with contaminants, the method comprising the steps of:
a. providing a cleaning vessel containing a cleaning liquid, the cleaning liquid being non-reactive with the catalyst layer;
b. submerging at least a portion of a DPF in the cleaning liquid in the vessel;
c. operating one or more acoustic transducers in a frequency range of 20-100 kHz to induce pressure waves in the cleaning liquid that separate the filtered materials from the filter elements within the housing without removing the catalyst layer; and
d. removing the DPF from the cleaning liquid.

2. The method of claim 1, further comprising the step of
e. rinsing the DPF after removal from the cleaning liquid.

3. The method of claim 1, further comprising repeating steps b through d.

4. The method of claim 2, further comprising repeating steps b through e.

5. The method of claim 2, further comprising the step of drying the DPF after rinsing.

6. The method of claim 1, wherein the cleaning liquid comprises one or more of a group consisting of water, aqueous solution, surfactant, solvent, acidic solution, basic solution, and mixtures thereof.

7. The method of claim 1, wherein the DPF element is transferred into and from the cleaning vessel by a hoist.

8. The method of claim 1, wherein the cleaning vessel comprises one or more acoustic transducers capable of operating at frequencies between 2.0 kHz and 100 kHz.

9. The method of claim 1, wherein the one or more acoustic transducers are mounted to the cleaning vessel, the cleaning vessel being separate and distinct from the DPF.

10. The method of claim 1, wherein the one or more acoustic transducers are mounted inside the cleaning vessel.

11. The method of claim 1, wherein the one or more acoustic transducers are mounted outside the cleaning vessel.

12. The method of claim 1, wherein the one or more acoustic transducers are mounted using one of a fixed mount, a flexible mount, or a freely hanging mount.

13. The method of claim 1, wherein the one or more acoustic transducers are oriented in such a way as to deliver acoustic energy through the cleaning liquid to the exterior and interior surfaces of the DPF.

14. The method of claim 1, wherein the acoustic transducer generates pressure waves radially or longitudinally.

15. The method of claim 1, wherein rinsing the DPF comprises circulating fluid through the housing of the DPF.

16. The method of claim 1, wherein the cleaning vessel comprises a fluid exchange system having one or more pumps and one or more filters for separating solid contaminants from the cleaning fluid removed from the DPF.

17. The method of claim 16, further comprising settling tanks for separating solid contaminants.

18. The method of claim 16, wherein the separated cleaning fluid is used to rinse the DPF.

19. The method of claim 16, wherein the one or more filters comprise gravitational, centrifugal and size exclusion fillers.

20. The method of claim 16, further comprising the step of exchanging the cleaning liquid in the cleaning tank such that the solid contaminants removed from the DPF are separated from the cleaning liquid, the separated cleaning liquid being reused for at least one of cleaning and rinsing the DPF.

21. The method of claim 5, wherein drying the DPF comprises using a vacuum system.

22. The method of claim 21 wherein the vacuum system induces a local low pressure region in the DPF to promote cross channel flows.

23. The method of claim 22, wherein the vacuum system is coupled to the DPF wherein the filter elements are not removable from the housing.

24. The method of claim 21, further comprising the step of heating the air drawn through the DPF by the vacuum system.

25. The method of claim 21, further comprising the step of monitoring one or more of the airflow, the temperature, the pressure drop and the humidity of an air flow drawn through the DPF by the vacuum system to monitor the drying step.

26. The method of claim 1, further comprising the step of testing the DPF by applying a vacuum to the DPF and measuring the airflow and pressure drop across the DPF.
